(19) United States
(12) Patent Application Publication
(10) Pub. No.: US 2008/0185792 A1
(43) Pub. Date: Aug. 7, 2008

(54) Mandrel for a Milling Cutter

(76) Inventors: Sebastien Hopfner, Saverne (FR); Alain Freyermuth, Pfaffenhoffen (FR)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/660,017

(22) PCT Filed: Jul. 28, 2005
(86) PCT No.: PCT/FR2005/001982

§ 371 Date: Nov. 26, 2007

(30) Foreign Application Priority Data
Aug. 9, 2004 (FR) 0408756

(51) Int. Cl. B23C 5/26; B23B 31/117; B23B 31/40

(52) U.S. Cl. 279/2.06; 409/218

(57) ABSTRACT

The present invention relates to a mandrel for a milling cutter holder, which consists of a mounting body (1) for mounting on a tool holder and is equipped with a fixation hub (2) of a milling cutter body (3).

Mandrel for a milling cutter holder characterized in that the fixation hub (2) of a milling cutter body (3) is water expandable.

The invention can be applied more particularly in the field of accessories for machine tools, with digital control, for machining centers, cells and workshops with multiple purposes.

The present invention concerns the field of accessories for machine tools, with digital control, for machining centers, cells and workshops with multiple purposes, and its object is a water expandable mandrel for a milling cutter holder.

The milling tools or milling cutters used in the above-mentioned machines are generally in the form of substantially cylindrical elements, which are mounted with a bore to the hub of the tool holder, and tightened to the latter with a screw.

Such a method for mounting milling cutters allows a correct tightening of the latter. However, because of the increase in the performance levels of modern machines, and thus the resulting high cutting rates, the precision of the mounting of these tools becomes crucial.

Indeed, today the mounting must be carried out with perfect centering, a demand which is almost incompatible with the currently used centering procedure by simple adjustment.

Moreover, U.S. Pat. No. 4,387,906 discloses a mounting and tightening device which uses a conical part as well as an intermediate piece to ensure the centering. Such a mounting allows only a limited machining precision, because it is impossible to ensure perfect concentricity and centering.

The purpose of the present invention is to overcome these drawbacks by proposing a mandrel for a milling cutter holder which allows the perfect and reproducible centering and tightening of the tool, without specific adaptation during the operations of tool replacement.

For this purpose, the mandrel for a milling cutter holder according to the invention which consists of a mounting body on a tool holder, and which is equipped with a fixation hub of a milling cutter body, is characterized in that the fixation hub of a milling cutter body is hydraulically extendible.

The invention will be understood better thanks to the following description which relates to a preferred embodiment which is given as a nonlimiting example and explained in reference to the schematic drawings in the appendix, in which:

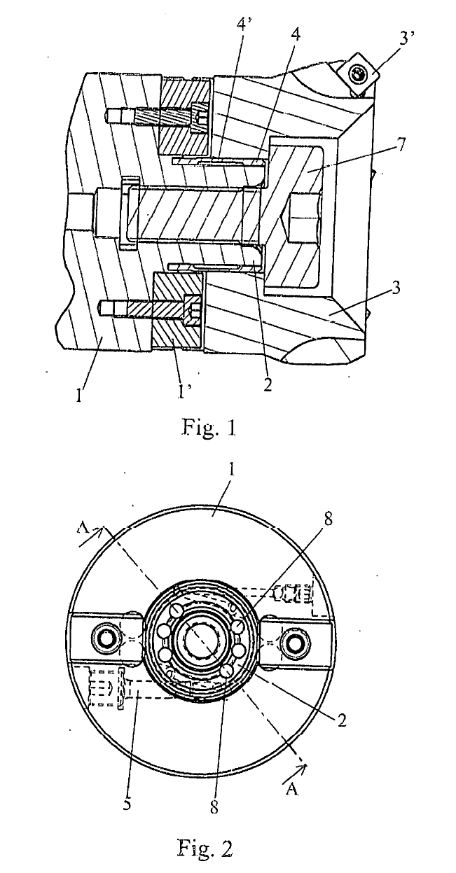

FIG. 1 is a lateral elevation view with partial cross section through a mandrel for a milling cutter holder according to the invention which is equipped with a milling tool;

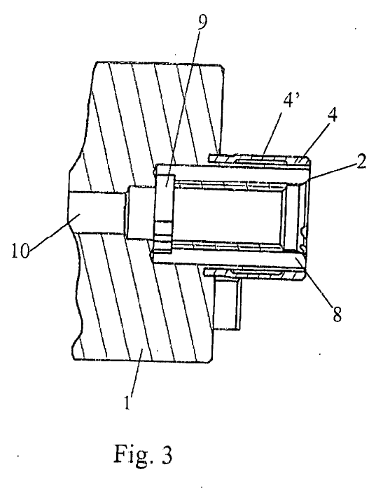

FIG. 2 is a front elevation view of the mandrel alone, and

FIG. 3 is a cross-sectional view along line A-A of FIG. 2.

FIGS. 1-3 of the drawings in the appendix represent, as an example, a mandrel for a milling cutter holder, which consists of a body 1 for mounting on a tool holder, which is equipped with a fixation hub 2 of a milling cutter body 3.

According to the invention, the fixation hub 2 of a milling cutter body 3 is hydraulically extendible. For this purpose, the hub 2 presents an external sleeve 4, which is provided with an annular chamber 4′ having an external wall of small thickness, where this chamber is connected to a pressurization hub 5 which traverses the body 1.

The pressurized fluid is advantageously oil, and the delivery of this pressurized oil into the annular chamber 4′ of the sleeve 4, due to the effect of the high pressure of the oil injected into said chamber 4′, causes consequently an elastic deformation of its external wall, which is thus pressed against the wall of the central bore of the milling cutter 3.

As a result, because of the uniform distribution of the pressure in the annular chamber 4′, a regular deformation of the external wall delimiting this chamber occurs, so that the milling cutter 3 is automatically centered on the hub 2 of the body 1. Since the milling cutter 3 has been mounted beforehand on the hub 2 and straddles the drivers 1′ of the body 1 with a slight tightening by means of the tightening screw 7 to ensure a proper securing, it will be sufficient, after the pressurization of the chamber 4′, to strongly tighten the screw 7 in the hub 2 of the body 1 to fix the milling cutter 3 definitively on said hub 2.

It is preferred for the external sleeve 4 to be a connected piece that is fixed to the hub 2 by hooping, brazing or other means, and for the pressurization means 5 to be connected advantageously to the annular chamber 4′ with a bore which is arranged, in a known manner, in the hub 2, and opens, through the latter's wall, into the annular chamber 4′.

According to another characteristic of the invention, and as shown more particularly in FIGS. 2 and 3 of the drawings in the appendix, the hub 2 of the milling cutter holder body 1 is advantageously provided, in addition, with longitudinal bores 8 extending parallel to its axis in the periphery of the hub 2, and opening on its front face to communicate with the lubrication ducts, not shown, which are provided in the body of the milling cutter 3 to open near the cutting plates 3′ of the milling cutter, where these longitudinal ducts 8 open at their other end into a chamber 9 connected to an axial duct 10 for supplying lubrication liquids. The chamber 9, for example, can correspond to a recess provided in the body 1 close to the end of the tightening screw 7 of the milling cutter 3, when the screw is completely tightened.

Thanks to the invention, it is possible to produce a mandrel for a milling cutter holder, which allows the obtention of a perfect centering of the tool, so that its regulation can be carried out in a perfect and reproducible manner without specific adaptation to each tool. In addition, providing lubrication ducts on the periphery of the hub 2 ensures a good supply of lubrication fluid in the front part of the tool.

Naturally, the invention is not limited to the embodiment which has been described and represented in the drawings of the appendix. Modifications remain possible, notably with regard to the constitution of the different elements or substitution with technical equivalent means, without thereby exceeding the scope of protection of the invention.

1. Mandrel for a milling cutter holder, comprising a mounting body (1) for mounting on a tool holder and is equipped with a fixation hub (2) of a milling cutter body (3), characterized in that the fixation hub (2) of a milling cutter body (3) is hydraulically extendible and presents an external sleeve (4) which is provided with an annular chamber (4′) having an external wall of small thickness, where this chamber is connected to a pressurization means (5) which traverses the body (1).

2. (canceled)

3. Mandrel for a milling cutter holder according to claim 1, characterized in that the external sleeve (4) is a connected piece which is fixed to the hub (2) by hooping, brazing or other means, and the pressurization means (5) is connected to the annular chamber (4′) through the intermediary of a bore which is provided in the hub (2) and opens through the latter's wall into the annular chamber (4′).

4. Mandrel for a milling cutter holder according to claim 1, characterized in that the hub (2) of the milling cutter holder body (1) is provided, moreover, with the longitudinal bores (8) which extend parallel to its axis in the periphery of the hub (2) and open on its front face to communicate with lubrication ducts provided in the body of the milling tool (3) to open near the cutting plates (3′) of the latter, where these longitudinal ducts (8) open at their end into a chamber (9) connected to an axial duct (10) for supplying liquids.
